(19) United States
(12) Patent Application Publication
(10) Pub. No.: US 2008/0314708 A1
(43) Pub. Date: Dec. 25, 2008

(54) Piston-cylinder unit

(75) Inventors: Dieter Eulenbach, Eitorf (DE); Hubert Beck, Eitorf (DE)

Correspondence Address: COHEN, PONTANI, LIEBERMAN & PAVANE LLP, 551 FIFTH AVENUE, SUITE 1210, NEW YORK, NY, 10176, US

(73) Assignee: ZF Friedrichshafen AG, Friedrichshafen (DE)

(21) Appl. No.: 12/214,432

(22) Filed: Jun. 19, 2008

(30) Foreign Application Priority Data
Jun. 21, 2007 (DE) 10 2007 028 634.3

(51) Int. Cl. F16F 9/512

(52) U.S. Cl. 188/314; 267/126

(57) ABSTRACT

Presented is a piston-cylinder unit. The piston-cylinder unit includes an outer tube defining a cavity, a working cylinder disposed in the cavity of the outer tube and filling only a portion of the cavity. The unfilled portion of the cavity is a compensating space. The compensating space is divided into an area filled with a damping medium and an area filed with a gas. The piston-cylinder unit further includes a piston rod that includes a damping piston. The piston rod is disposed in the working cylinder and has freedom of axial movement, and is configured to displace the gas. The piston-cylinder unit further includes a reservoir that has a variable volume configured for actuating the compensating space.

### BACKGROUND OF THE INVENTION

1. Field of the Invention

The invention relates generally to piston-cylinder units, and more particularly to piston-cylinder units that include a space filled in part with a damping medium and in part with gas.

2. Description of the Related Art

Vibration dampers are already known, for example, from DE 10 2005 025 511 B3 in which the working cylinder has a damping piston mounted on a piston rod, where the damping piston is installed with freedom of axial movement in the working cylinder and in which a flow connection proceeding from the lower working space connects the lower working space to a compensating space. The damping medium displaced by the piston rod when the piston rod travels into the working cylinder is displaced via the flow connection into the compensating space. Inside the compensating space, the damping medium is separated by a separating piston from a gas medium in the upper area of the compensating space. This is a compensating space, which is located outside the piston-cylinder unit, which is designed as a single-tube vibration damper and in which the compensating space is filled with damping medium and a gaseous medium.

Self-pumping hydropneumatic spring struts are also known, in which a low-pressure space to hold damping medium and a high-pressure space to hold both damping medium and a gas cushion are arranged coaxially to the working space. The hollow piston rod cooperates with a pump rod to form an automatic level control system, which, while the vehicle is traveling, is able to raise a fully loaded vehicle back to its normal level by conveying damping medium from the low-pressure space into a high-pressure space by means of the pumping movements of the hollow piston rod, which acts together with the pump rod. This automatic upward adjustment of the vehicle body can be actuated only while the vehicle is being driven, because it is the irregularities of the road surface, which cause the piston rod to move relative to the pump rod. To raise a fully loaded motor vehicle back to its normal level while it is standing still, a so-called parking level control system consisting of an electric motor and a piston, driven by way of a gear unit, is used to convey damping medium from the low-pressure space to the high-pressure space of the self-pumping hydropneumatic spring strut.

### SUMMARY OF THE INVENTION

An object of the invention is to improve a piston-cylinder unit having a space filled in part by gas and in part with a damping medium so that the level of the body of a vehicle can be automatically controlled by simple means.

The object of the invention is met in that the compensating space is actuated directly and/or indirectly by a reservoir of variable volume.

The advantage of this embodiment is that the compensating space of a piston-cylinder unit, which is configured to accept the damping medium displaced by the piston rod, can be actuated directly and/or indirectly with additional damping medium from an additional reservoir so that the piston rod together with the damping piston can be pushed outward by the actuation of the working spaces with additional damping medium and by a corresponding pretension of the gas-filled compensating space.

According to one embodiment, a displacing element, which changes the volume of the reservoir, is provided in the reservoir. It is advantageous here for the displacing element to be actuated externally.

According to another embodiment, the displacing element is actuated by an electric motor. It is advantageous here for a gear unit to be provided between the displacing element and the electric motor.

To achieve an appropriate level of efficiency, a threaded spindle, a recirculating ball gear, a worm gear, or a planetary gear is provided as the gear unit. Different types of gear units can be provided, where gears with an appropriate self-locking function are preferred, although low-friction recirculating ball gears can be also be provided. If a recirculating ball gear is used, however, it is also necessary to provide a device capable of preventing the displacing element from being moved.

A compact structural unit is obtained by locating the compensating space coaxially between the working cylinder and an outer tube and by having the reservoir open directly into the outer tube.

If the installation space available does not allow a compact unit, however, it is also possible for the reservoir to be connected to the compensating space by means of a flow connection.

Other possible designs consist in locating the compensating space and the reservoir outside the piston-cylinder unit. It is advantageous here for only the piston-cylinder unit to be provided between the vehicle body and the wheel suspension and for both the reservoir and the compensating space to be located, by way of an appropriate flow connection, at any suitable point in the vehicle not in the immediate vicinity of the piston-cylinder unit.

According to another feature, the electric motor is actuated manually or automatically by a sensor. According to this solution, either the piston-cylinder unit is actuated manually, or an independently working level control system can be achieved by the use of appropriate sensors to detect the position of the vehicle body.

The vehicle can also be stabilized against rolling movements by appropriate actuation of the piston-cylinder units at the various wheels of the vehicle. In this case, only inside-curve and outside-curve piston-cylinder units of the wheel to be stabilized are actuated independently of each other.

According to another embodiment, a shut-off valve operating as a function of flow is provided between the compensating space and the reservoir, or a shut-off valve operating as a function of pressure is provided between the compensating space and the reservoir. It is advantageous here that forces which surge abruptly into the piston-cylinder unit have no effect on the actual level control function itself, i.e., forces which otherwise would simulate an unloaded or a loaded vehicle.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Preferred exemplary embodiments of the invention are illustrated schematically in the drawings.

FIG. 1 is an illustrative cross-sectional diagram of a piston-cylinder unit together with a compensating space and a reservoir, according to one embodiment of the invention.

FIG. 2 is an illustrative cross-sectional diagram of a piston-cylinder unit together with a compensating space and a reservoir, according to the embodiment of FIG. 1.

FIG. 3 is an illustrative cross-sectional diagram of reservoirs in isolation, according to another embodiment of the invention.

FIG. 4 is an illustrative cross-sectional diagram of reservoirs in isolation, according to the embodiment of FIG. 3.

FIG. 5 is an illustrative schematic circuit diagram of a piston-cylinder unit of the type shown in FIG. 1.

FIG. 6 is an illustrative perspective diagram of a piston-cylinder unit connected to a reservoir by a flow connection, according to one embodiment of the invention.

FIG. 7 is an illustrative cross-sectional diagram of a reservoir together with an electric motor and a gear unit, according to one embodiment of the invention.

FIG. 8 is an illustrative side view of a piston-cylinder unit and a reservoir arranged in parallel to each other, according to yet another embodiment of the invention.

FIG. 9 is an illustrative top view of two piston-cylinder units, each of which is connected by a flow connection to a reservoir, according to a further embodiment of the invention.

FIG. 10 is an illustrative schematic diagram of a piston-cylinder unit together with a reservoir, and a flow-dependent shut-off valve disposed in the path of the flow connection, according to one embodiment of the invention.

FIG. 11 is an illustrative schematic diagram of a piston-cylinder unit together with a reservoir, and a flow-dependent shut-off valve disposed in the path of the flow connection, according to the embodiment of FIG. 10.

FIG. 12 is an illustrative schematic diagram of a piston-cylinder unit together with a reservoir, and a pressure-dependent shut-off valve disposed in the path of the flow connection, according to one embodiment of the invention.

FIG. 13 is an illustrative schematic diagram of a piston-cylinder unit together with a reservoir, and a pressure-dependent shut-off valve disposed in the path of the flow connection, according to the embodiment of FIG. 12.

### DETAILED DESCRIPTION OF THE PRESENTLY PREFERRED EMBODIMENTS

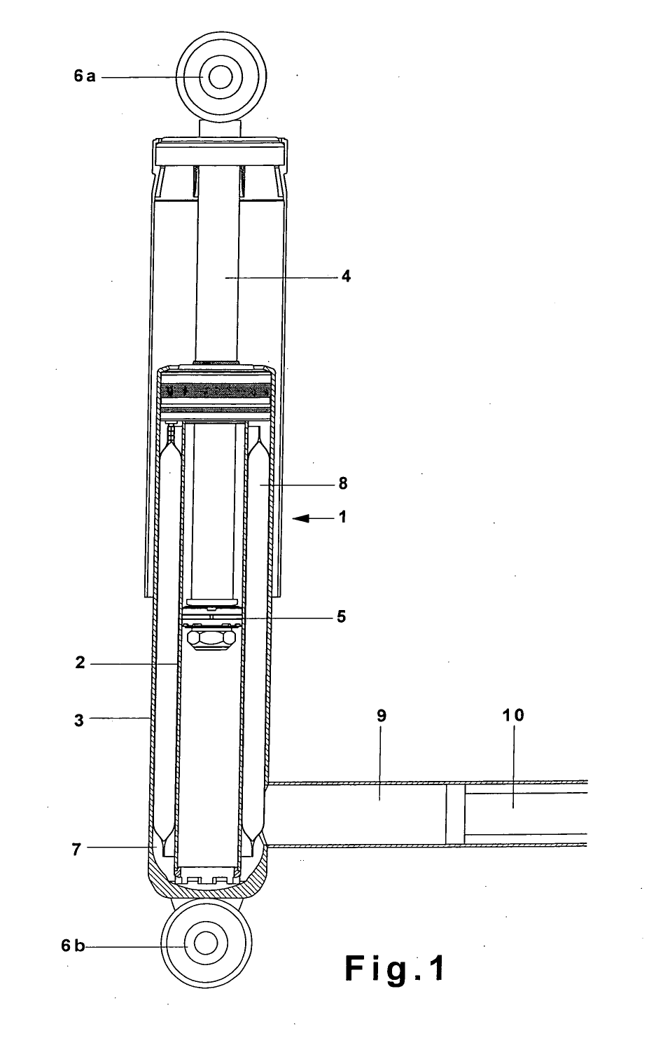

Referring to FIG. 1, a piston-cylinder 1 includes a working cylinder 2 and an outer tube 3, where, in the working cylinder 2, a damping piston 5, mounted on a piston rod 4, is installed with freedom of axial movement. The fastening elements 6a and 6b serve to attach the piston-cylinder 1 to the vehicle body and to a wheel suspension (not shown) of a motor vehicle.

A compensating space, which consists of a damping medium-filled area 7 and a gas-filled area 8, is provided between the outer tube 3 and the working cylinder 2.

A reservoir 9, illustrated schematically, is actuated by a displacing element 10. The reservoir 9 leads directly through the outer tube 3 to the damping medium-filled area 7. FIG. 1 shows the reservoir 9 in an unpressurized state.

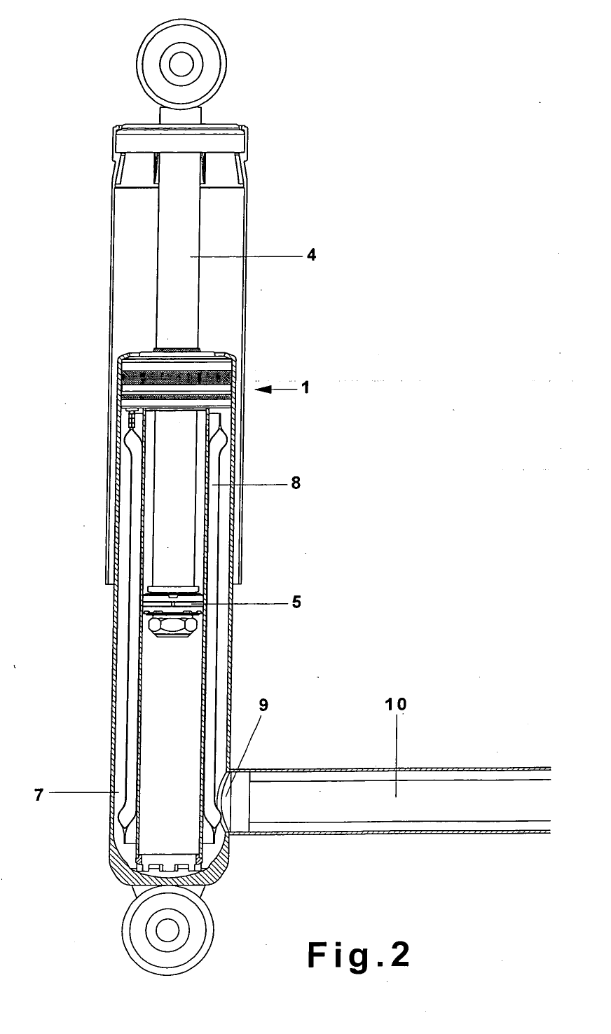

FIG. 2 shows the piston-cylinder unit 1 of FIG. 1, where the displacing element 10 has reduced the reservoir 9 to a minimum, so that the corresponding damping medium previously present in the reservoir 9 has arrived in the damping medium-filled area 7 of the compensating space. The gas-filled area 8 is thus compressed, and an elevated internal pressure, which pushes the damping piston 5 together with the piston rod 4 outward, prevails in the working cylinder 2.

This means that, after a significant amount of weight has been added to the vehicle, the piston of FIG. 2 occupies the same position as that shown in FIG. 1, but now a much higher internal pressure is present in the working cylinder 2.

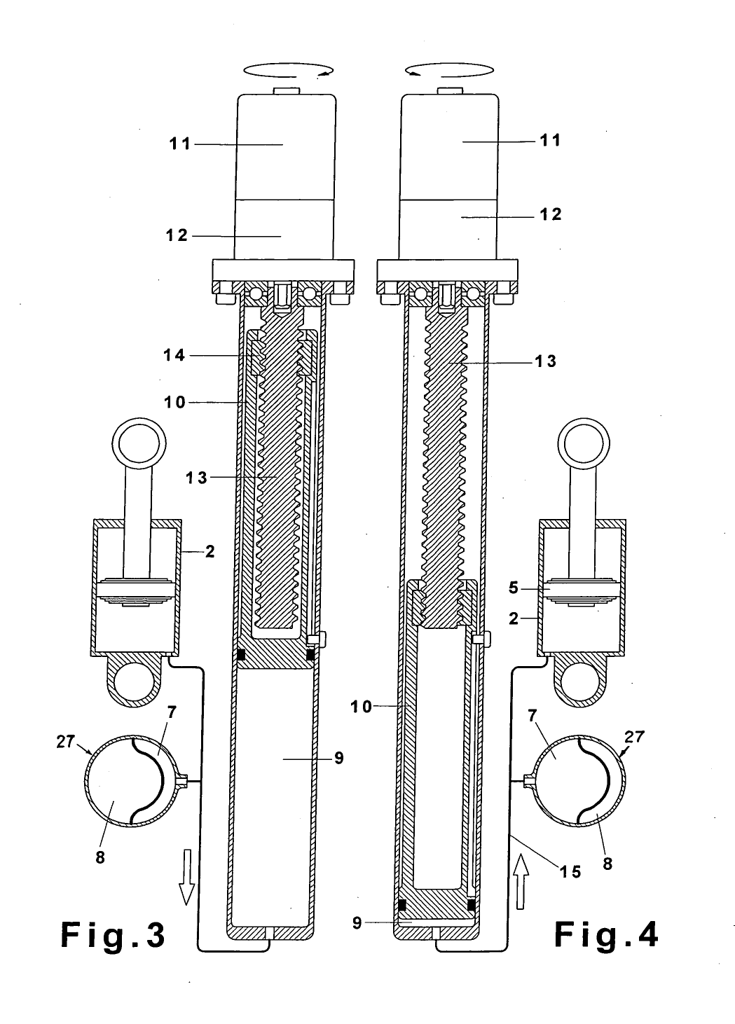

FIGS. 3 and 4 show an embodiment in which the compensating space is arranged in a pressure accumulator 27 connected between the reservoir and the working cylinder 2. In FIG. 3, the reservoir 9 is shown, and in which the displacing element 10 is free to move back and forth axially under the action of an electric motor 11 and a gear unit 12. In the interior of the displacing element 10, a threaded spindle 13 is provided. The electric motor 11 drives the threaded spindle 13 to displace element 10 in the axial direction via a nut 14. Alternatively, however, the nut 14 could be mounted on the gear unit 12, and the threaded spindle 13 could be connected to the displacing element.

FIG. 4 shows the displacing element 10 in a position in which it has reduced the reservoir 9 to a minimum. The nut 14 mounted in the displacing element 10 is prevented from rotating, while the threaded spindle 13 is driven to rotate by the electric motor 11 and the gear unit 12. The damping medium disposed in the reservoir 9 flows through the flow connection 15 and into the damping medium-filled area 7 of the compensating space in response to the displacing element 10, thereby compressing the gas-filled area 8. The pressure in the working cylinder 2 thus increases, so that the damping piston 5 is pushed outward by the pressure of the reservoir 9, which acts on the pressure-actuated surface of the damping piston 5.

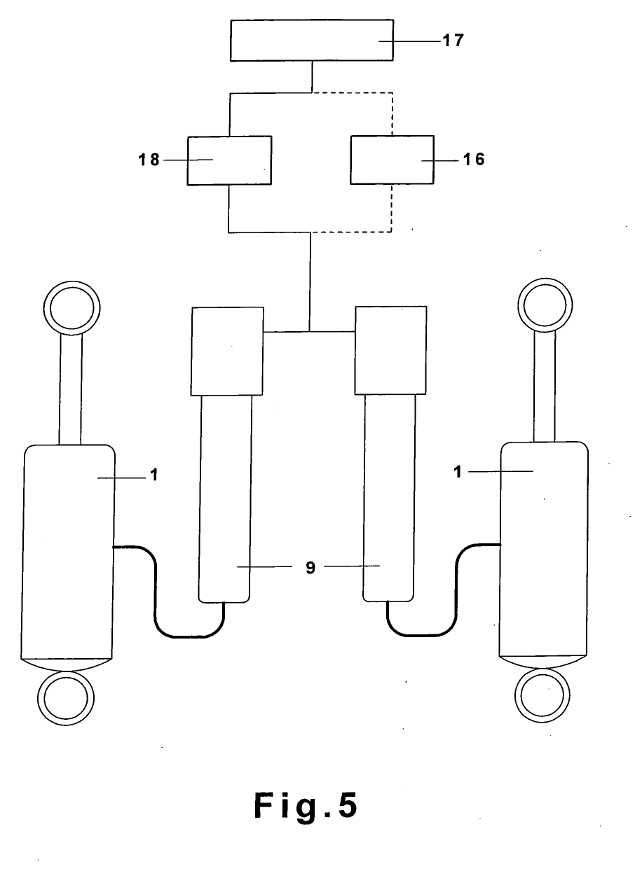

FIG. 5 shows a circuit diagram, in which the piston-cylinder unit 1 and the reservoir 9 are switched on either by the use of a manual switch 16 or automatically by an electronic circuit 18, controlled by at least one sensor 17. It is thus possible to control the level of the motor vehicle. Alternatively, this circuit can also be used to stabilize the vehicle body against rolling movements.

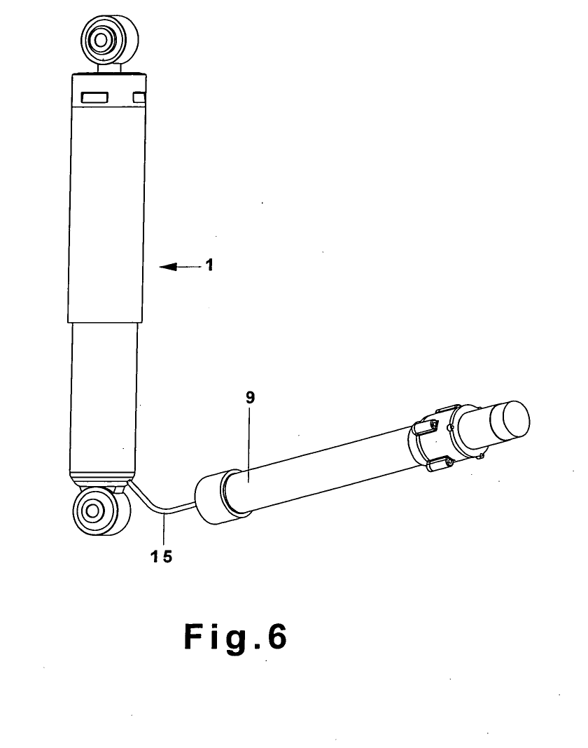

FIG. 6 shows a side view of another embodiment of the present invention in which a piston-cylinder unit 1 and a reservoir 9, are connected by a flow connection 15 so that the reservoir 9 is connected the damping medium-filled area 7.

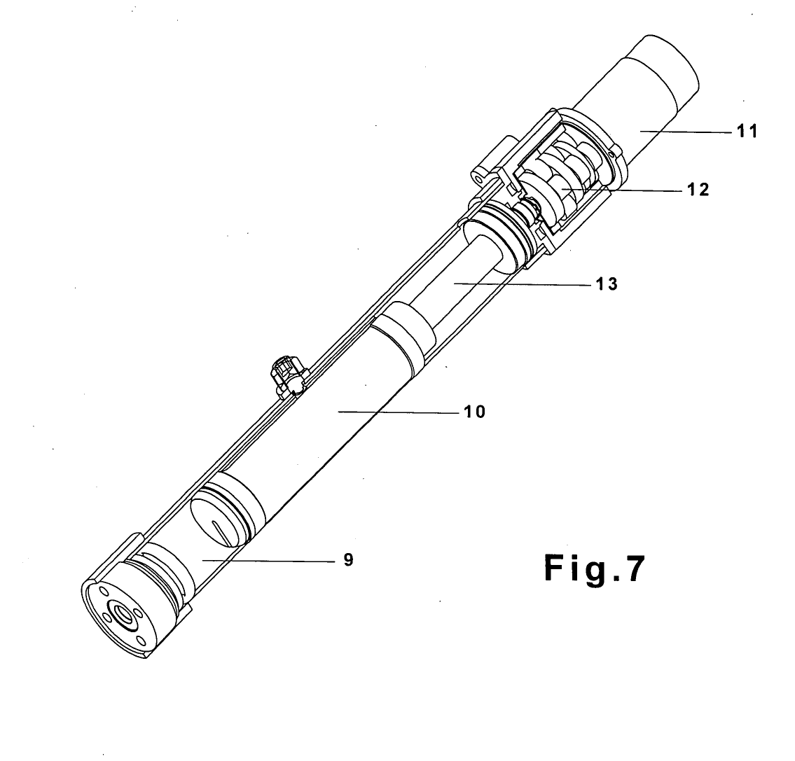

FIG. 7 shows the reservoir 9 in isolation, in which the displacing element 10 is actuated by the threaded spindle 13, the gear unit 12, and the electric motor 11. The electric motor 11 can move the displacing element 10 in either axial direction.

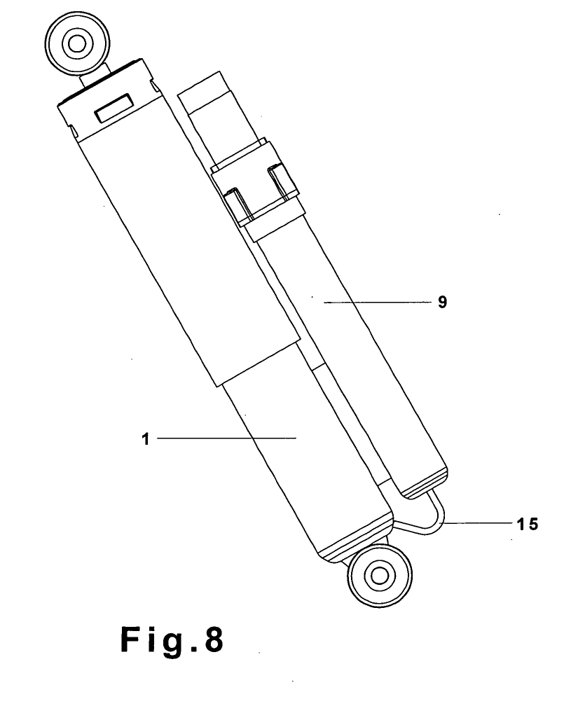

FIG. 8 shows a further arrangement in which the piston-cylinder unit 1 and the reservoir 9 are disposed on parallel axes and the reservoir 9 is connected to the damping medium-filled area 7 of the piston-cylinder unit 1 by the flow connection 15.

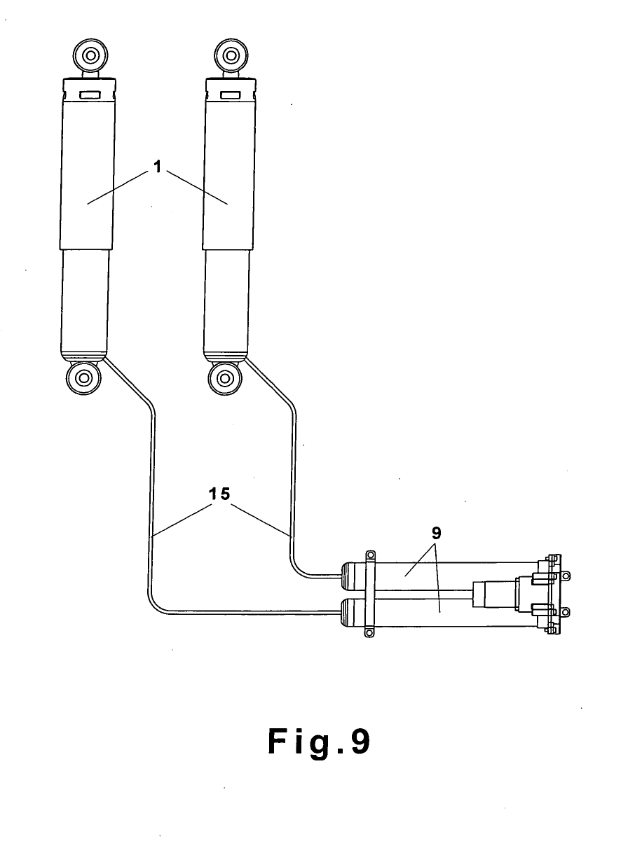

Referring to FIG. 9, in another embodiment, two piston-cylinder units 1 are connected to two separate reservoirs 9 by appropriate flow connections 15. The reservoirs 9 can be easily accommodated at any desired point in the vehicle.

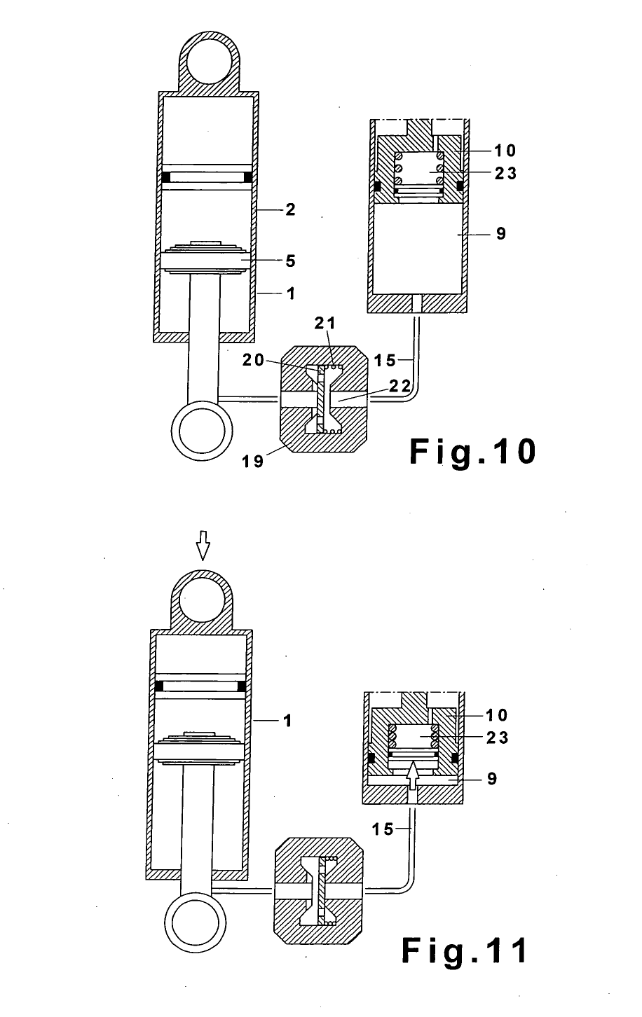

FIGS. 10 and 11 each show a schematic diagram of an embodiment of a piston-cylinder unit 1 together with a reservoir 9, in which a flow-dependent shut-off valve 19 is installed in the flow connection 15. When the flow rate increases beyond a certain point (i.e., when the damping piston 5 travels quickly into the working cylinder 2), the axially movable valve plate 20 installed in the valve moves against the force of the spring 21 and thus closes off the passage 22, as shown in FIG. 11. As the flow rate decreases, the force of the spring 21 pushes the valve plate 20 back, thus unblocking the passage 22. A shock-absorbing element 23 is provided in the displacing element 10 and prevents the displacing element 10 from moving while the shut-off valve 19 is closed.

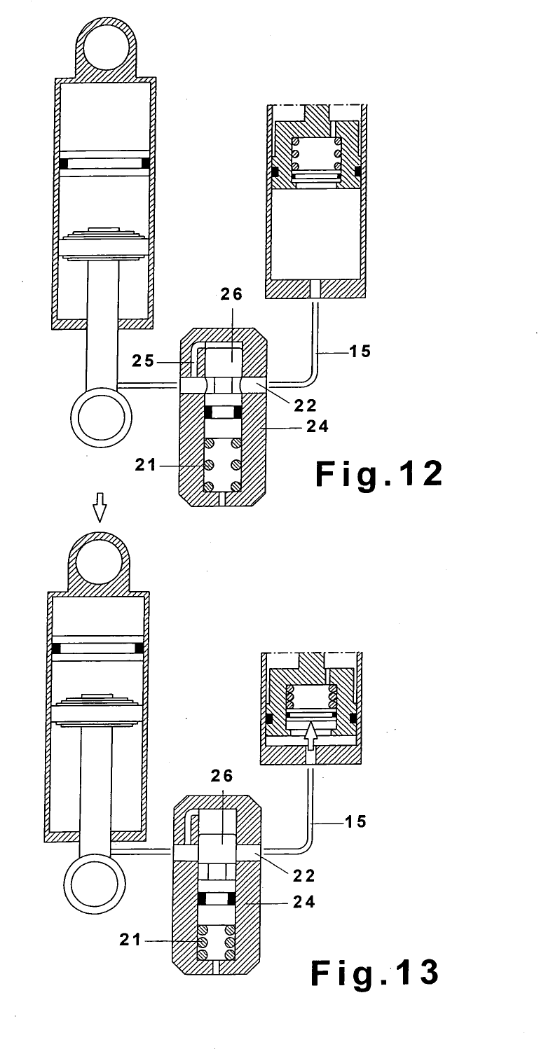

FIGS. 12 and 13 show a pressure-dependent shut-off valve 24 in the flow connection 15, in which a valve body 26 acts against a spring 21. When the pressure builds up in the channel 25, this valve body 26 is pushed against the spring 21 and thus closes the passage 22. A closed valve can be seen in FIG. 13. After the impact-like pressure surge has been absorbed in the piston-cylinder unit and the pressure has normalized again, the valve body 26 is pushed back into its original position by the spring 21, so that the passage 22 is opened again.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A piston-cylinder unit, comprising:
a working cylinder;
a piston rod comprising a damping piston, the piston rod being disposed in the working cylinder and having freedom of axial movement, the damping piston dividing the working cylinder into two working spaces;
a compensating space having an area filled with gas and an area filled with damping medium, said compensating space being connected to said working cylinder for receiving damping medium displaced by said piston rod; and
a reservoir having a variable volume configured for actuating the compensating space.

2. The piston-cylinder unit according to claim 1, further comprising a displacing element disposed in the reservoir, wherein the displacing element changes the volume of the reservoir.

3. The piston-cylinder unit according to claim 2, wherein the displacing element is driven externally.

4. The piston-cylinder unit according to claim 2, further comprising an electric motor configured for actuating the displacing element.

5. The piston-cylinder unit according to claim 4, further comprising a gear unit disposed between the displacing element and the electric motor.

6. The piston-cylinder unit according to claim 5, wherein the gear unit comprises a threaded spindle, a recirculating ball gear, a worm gear, or a planetary gear.

7. The piston-cylinder according to claim 1, further comprising an outer tube, wherein the compensating space is located coaxially between the working cylinder and an outer tube, and the reservoir opens directly into the outer tube.

8. The piston-cylinder unit according to claim 1, further comprising a flow connection connecting the reservoir to the compensating space.

9. The piston-cylinder unit according to claim 1, wherein the compensating space and the reservoir are located outside the piston-cylinder unit.

10. The piston-cylinder unit according to claim 4, further comprising a sensor that manually or automatically actuates the electric motor.

11. The piston-cylinder unit according to claim 1, further comprising a shut-off valve disposed between the compensating space and the reservoir, the shut-off valve operating as a function of flow.

12. The piston-cylinder unit according to claim 1, further comprising a shut-off valve disposed between the compensating space and the reservoir, the shut-off valve operating as a function of pressure.

13. The piston-cylinder unit according to claim 9, wherein the compensating space is in a pressure accumulator.
